(19) United States
(12) Patent Application Publication
(10) Pub. No.: US 2024/0075478 A1
(43) Pub. Date: Mar. 7, 2024

(54) APPARATUS CONFIGURED TO REMOVE FLEXIBLE MATERIALS FROM ROTATING ELEMENTS AND ASSOCIATED METHODS

(71) Applicant: Battelle Energy Alliance, LLC, Idaho Falls, ID (US)

(72) Inventors: Jeffrey A. Lacey, Idaho Falls, ID (US); Blesson Isaac, Idaho Falls, ID (US); Mark E. Small, Shelley, ID (US); Zachary P. Smith, Fort Collins, CO (US); Patrick N. Bonebright, Idaho Falls, ID (US)

(21) Appl. No.: 18/460,434

(22) Filed: Sep. 1, 2023

Related U.S. Application Data
(60) Provisional application No. 63/374,326, filed on Sep. 1, 2022.

(51) Int. Cl. B02C 4/40; B02C 4/08

(52) U.S. Cl. CPC B02C 4/40; B02C 4/08

(57) ABSTRACT

An apparatus for removing flexible material from rotating equipment includes a cutter assembly integrated into the rotating equipment. The cutter assembly includes a cutter shaft, a cutter blade coupled to the cutter shaft, and a movement mechanism configured to move the cutter assembly along an axis of the rotating equipment to cut accumulated material from the rotating equipment.

### CROSS-REFERENCE TO RELATED APPLICATION

This application claims the benefit under 35 U.S.C. § 119(e) of U.S. Provisional Patent Application Ser. No. 63/374,326, filed Sep. 1, 2022, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure relates to devices, apparatus, and methods for removing flexible materials from equipment. Specifically, the disclosure relates to devices, apparatus, and methods for removing flexible, plastic materials from rotating equipment, such as municipal waste processing equipment, food processing equipment, or agricultural equipment.

### BACKGROUND

Municipal solid waste is generated as a result of consumer products and packaging used in household applications. In many geographic areas, the waste that is generated is collected and sent to a municipal recovery facility where it is processed and subsequently disposed of. During processing, a stream of waste particles (e.g., feedstock) may be processed by equipment including multiple pieces of machinery (e.g., roller conveyors and shredders).

Flexible plastic packaging (FPP) is a ubiquitous component of municipal solid waste, and is present as garbage bags, shopping bags, packaging, and sanitation. When items of FPP found in municipal solid waste are processed through a conventional municipal recovery facility, the FPP tend to wrap around rotating shafts and other rotating components of processing equipment such as roller conveyors, rolling screens, and shredders.

FPP is a low-value feedstock and is not easily recyclable, therefore there is little commercial interest in recovering this fraction of the feedstock. Municipal recovery facilities have attempted to lessen the impact of FPP, such as by manually removing the FPP out of the incoming feedstock, but this often fails to remove all FPP from the feedstock.

### BRIEF SUMMARY

In accordance with one embodiment described herein, an apparatus for removing flexible material from rotating equipment includes a roller assembly including a cutter recess defined in one or more components of the roller assembly, the cutter recess extending radially toward a rotational axis of the roller assembly. The apparatus further includes a cutter assembly operable between a stored position within the cutter recess and an extended position. The cutter assembly includes a cutter shaft and a cutter blade coupled to the cutter shaft. The apparatus also includes a movement mechanism configured to move the cutter assembly parallel to the rotational axis of the roller assembly to cut accumulated material from the roller assembly.

In accordance with another embodiment described herein, an apparatus configured to remove flexible material from rotating includes a roller assembly positioned within a frame. The apparatus further includes at least one first shearing element extending radially from the roller assembly. The apparatus also includes at least one second shearing element secured to the frame and configured to contact the at least one first shearing element extending radially from the roller assembly.

In additional embodiments described herein, a method for removing material from rotating equipment. The method includes rotating a roller assembly of the rotating equipment, the roller assembly comprising a cutter recess defined radially outward from a rotational axis of the roller assembly. The method further includes moving a cutter assembly including a blade within the cutter recess parallel to the rotational axis of the roller assembly. The method also includes cutting material collected on the roller assembly with the blade of the cutter assembly.

### BRIEF DESCRIPTION OF THE DRAWINGS

FIG. 1 is a perspective view of a shredder assembly according to one or more embodiments of the disclosure;

FIG. 2 is an elevational view of an axial end of the shredder assembly of FIG. 1 along reference line 2;

FIG. 3 is an elevational view of the shredder assembly of FIG. 1 along reference line 3;

FIGS. 4 through 6 are top plan views of the shredder assembly of FIG. 1 in different states;

FIG. 7 is a perspective view of a roller assembly of the shredder assembly of FIG. 1;

FIG. 8 is an enlarged elevational view of a cutter assembly of the shredder assembly of FIGS. 5 and 6;

FIG. 9 is a perspective view of a roller assembly with a cutter assembly in an extended position according to one or more embodiments of the disclosure;

FIG. 10 is an elevational view of the roller assembly of FIG. 9 along reference line 10;

FIG. 11 is an elevational view of the roller assembly of FIG. 9 along reference line 11;

FIG. 12 is a cross-sectional view of the roller assembly of FIG. 11 along reference line 12;

FIG. 13 is a perspective view of a roller assembly according to one or more embodiments of the disclosure;

FIG. 14 is an elevational view of the roller assembly of FIG. 13 along reference line 14;

FIG. 15 is a cross-sectional view of the roller assembly of FIG. 14 along reference line 15;

FIG. 16 is an enlarged cross-sectional view of the roller assembly of FIG. 15;

FIG. 17 is a perspective view of a shredder assembly according to one or more embodiments of the disclosure;

FIG. 18 is a bottom plan view of the shredder assembly of FIG. 17;

FIG. 19 is an elevational view of the shredder assembly of FIG. 18 along reference line 19;

FIG. 20 is a bottom plan view of the shredder assembly of FIG. 17;

FIG. 21 is an elevational view of the shredder assembly of FIG. 20 along reference line 21; and

FIG. 22 is an enlarged cross-sectional view of a portion of the shredder assembly of FIG. 21.

### DETAILED DESCRIPTION

The illustrations included herewith are not meant to be actual views of any solid waste processing equipment, shredder assemblies, or roller assemblies, but are merely idealized representations that are employed to describe embodiments herein. Elements and features common between figures may retain the same numerical designation except that, for ease of following the description, for the most part, reference numerals begin with the number of the drawing on which the elements are introduced or most fully described.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “lower,” “upper,” “over,” “beneath,” “vertical,” “horizontal,” etc., is used for clarity and convenience in understanding the disclosure and accompanying drawings and does not connote or depend on any specific preference or order, except where the context clearly indicates otherwise. For example, these terms may refer to orientations of elements of core support assemblies and core support structures in conventional orientations. Furthermore, these terms may refer to orientations of elements of core support assemblies and core support structures as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

During the operation of solid waste processing equipment, flexible plastic packaging (FPP) or other flexible materials may become entangled on rotating components of the solid waste processing equipment which negatively affects the performance of the solid waste processing equipment. As FPP or other flexible materials become entangled around the rotating parts of the processing equipment, the accumulated FPP or other flexible materials degrade the operation and performance of the equipment sufficiently that an equipment shutdown may be required to remove the FPP or other flexible materials from the equipment. Once the processing equipment is shut down, personnel are sent to remove (e.g., manually cut) each piece of FPP or other flexible material from the rotating parts of the equipment. This may result in shutdowns of the entire processing line for hours at a time and puts the personnel in a dangerous work environment. The manual removal of the FPP or other flexible materials is also cost prohibitive.

Apparatus and methods as described herein may facilitate the mechanical removal of FPP and other flexible materials from rotating components of municipal solid waste processing equipment using an integrated design. A cutter assembly may be integrated into one or more of components of the solid waste processing equipment that move (e.g., rotate) during use and operation of the solid waste processing equipment. During use of the solid waste processing equipment, the integrated cutter assembly may be kept in a stored position within a cutter recess on a rotating component of the solid waste processing equipment. As FPP or other flexible materials accumulate on the rotating component, the solid waste processing equipment may be stopped and the cutter assembly and a movement mechanism may translate the cutter assembly across the rotating component to cut free accumulated FPP or other flexible materials. The cutter assembly may then be returned to the stored position and operation of the solid waste processing equipment may continue. The integrated cutter assembly may reduce equipment maintenance time and remove personnel from this dangerous environment while effectively removing the FPP or other flexible materials. While the apparatus and methods according to embodiments of the disclosure are described herein as being used to remove FPP or other flexible materials in the municipal solid waste industry, the apparatus and methods may be used to remove flexible materials from equipment used in other industries, such as in food processing and agriculture industries.

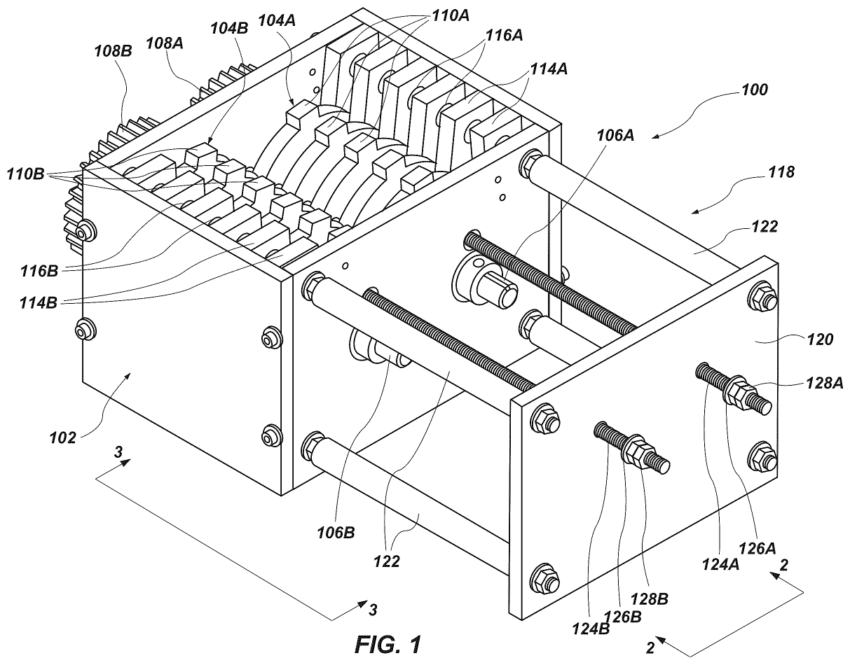

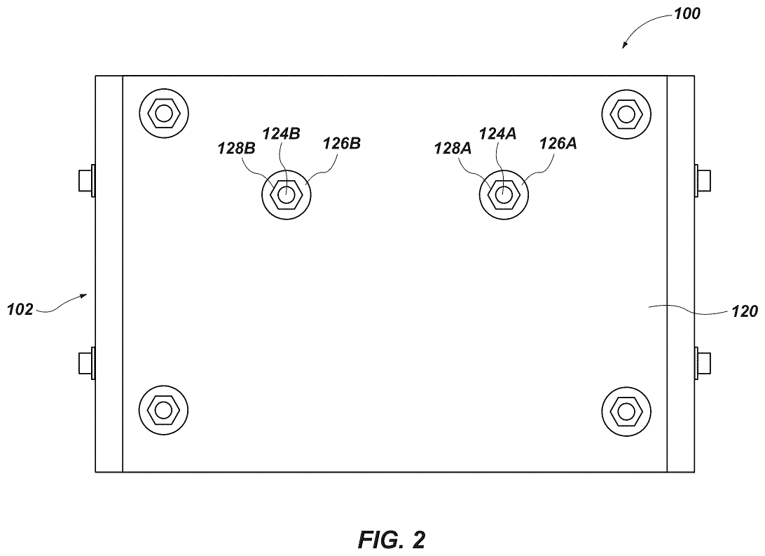

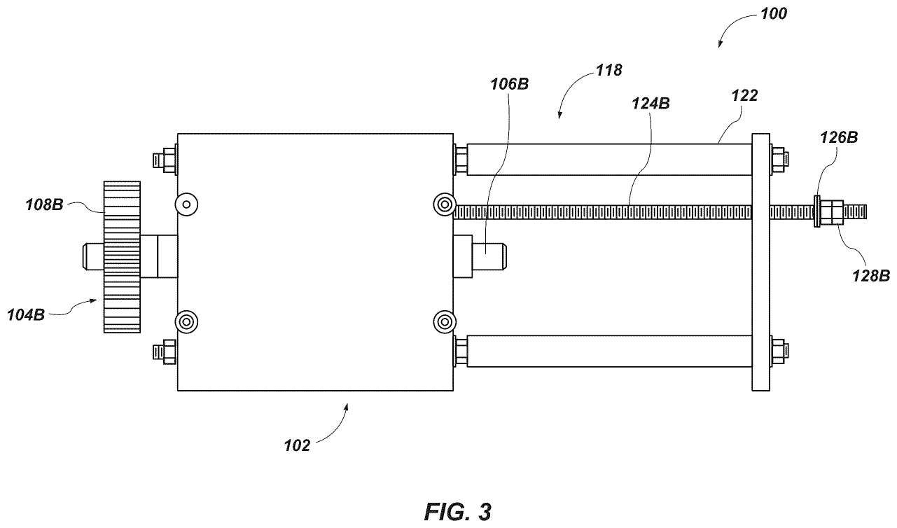

FIGS. 1 through 4 illustrate embodiments of a shredder assembly 100 utilized for the processing of municipal solid waste (e.g., solid waste) according to embodiments of the disclosure. The solid waste (not shown) may be transported (e.g., carried) to the shredder assembly 100 by mechanical elements, such as roller conveyors, heavy equipment, conveyor belts, etc., or by human intervention, such as manual insertion by a technician. The solid waste is inserted into the shredder assembly 100 via a top opening defined by a shredder frame 102.

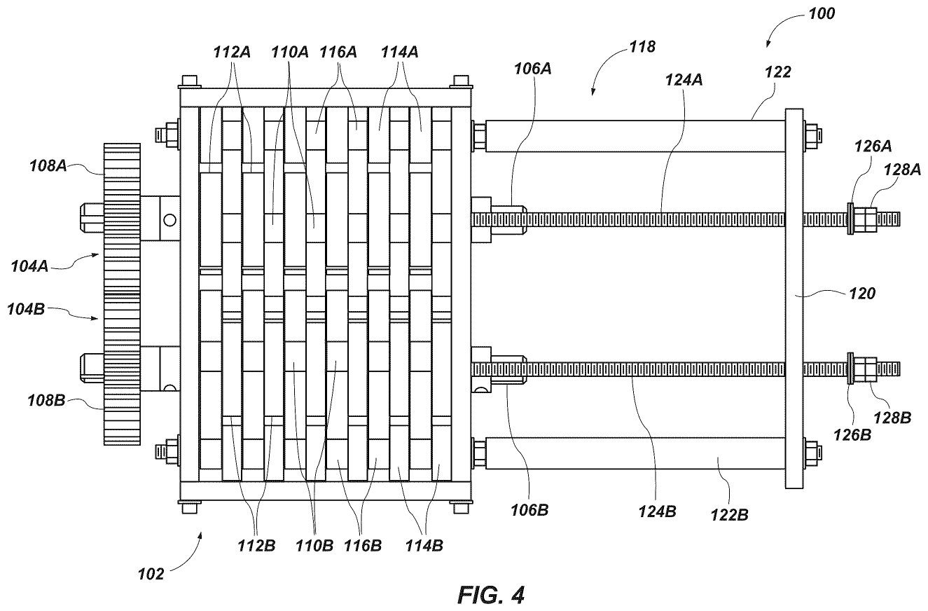

Upon insertion into the shredder assembly 100, the solid waste is engaged by at least one roller assembly 104A, 104B. Each roller assembly 104A, 104B includes a roller shaft 106A, 106B defining an axis upon which the roller assembly 104A, 104B rotates. The roller shaft 106A, 106B may be coupled (e.g., rotationally fixed) to a roller input gear 108A, 108B configured to receive mechanical energy to rotate the roller shaft 106A, 106B. In some embodiments, the roller input gear 108A, 108B is attached to a distal end of the roller shaft 106A, 106B and positioned outside the shredder frame 102. The roller assembly 104A, 104B additionally includes roller disks fixedly coupled to the roller shaft 106A, 106B. In some embodiments, the roller disks include one or more shredder disks 110A, 110B interspaced by one or more roller spacers 112A, 112B (shown at least in FIG. 4).

The shredder disks 110A of the first roller assembly 104A may be axially aligned with the spacers 112B of a second roller assembly 104B such that the shredder disks 110A of the first roller assembly 104A are interspaced with the shredder disks 110B of the second roller assembly 104B. Additionally, the first roller assembly 104A is positioned with the second roller assembly 104B such that the shredder disks 110A of the first roller assembly 104A overlap in a radially outward direction with the shredder disks 110B of the second roller assembly 104B.

Side plates 114A, 114B and side spacers 116A, 116B are fixedly coupled to the shredder frame 102 and interspaced such that the side plates 114A, 114B extend inward from the shredder frame 102 and mesh with the shredder disks 110A, 110B of the at least one roller assembly 104A, 104B.

The shredder assembly 100 additionally includes a cutter extension frame 118 coupled to the shredder frame 102. The cutter extension frame includes an extension plate 120 and at least one extension spacer 122 coupled between the extension plate 120 and the shredder frame 102 such that the extension plate 120 is coupled to the shredder frame 102 at a distance defined by the extension spacer 122.

The extension plate 120 and the shredder frame 102 define openings through which a movement mechanism may extend. As illustrated in FIGS. 1 through 7, the movement mechanism may include a retrieval rod 124A, 124B including a rod abutment 126A, 126B and a rod coupling 128A, 128B.

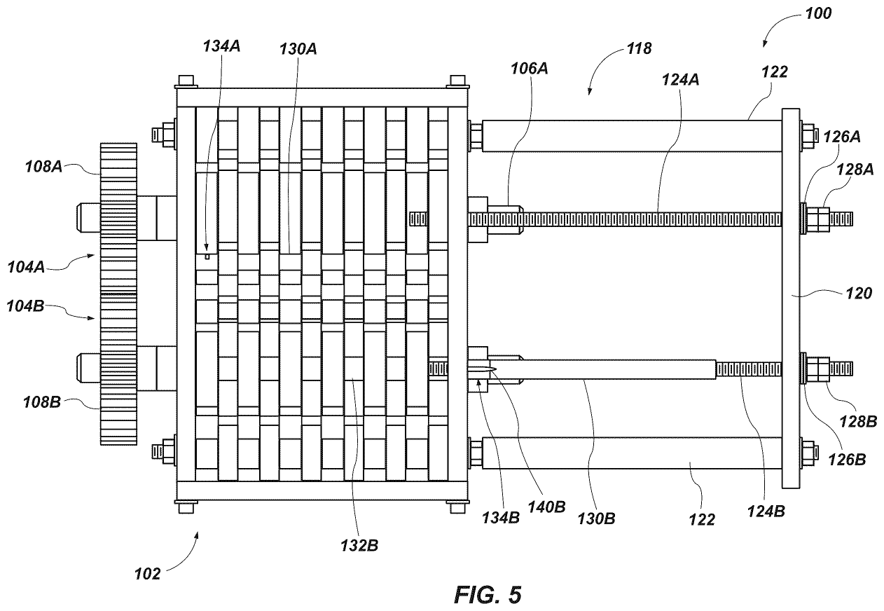

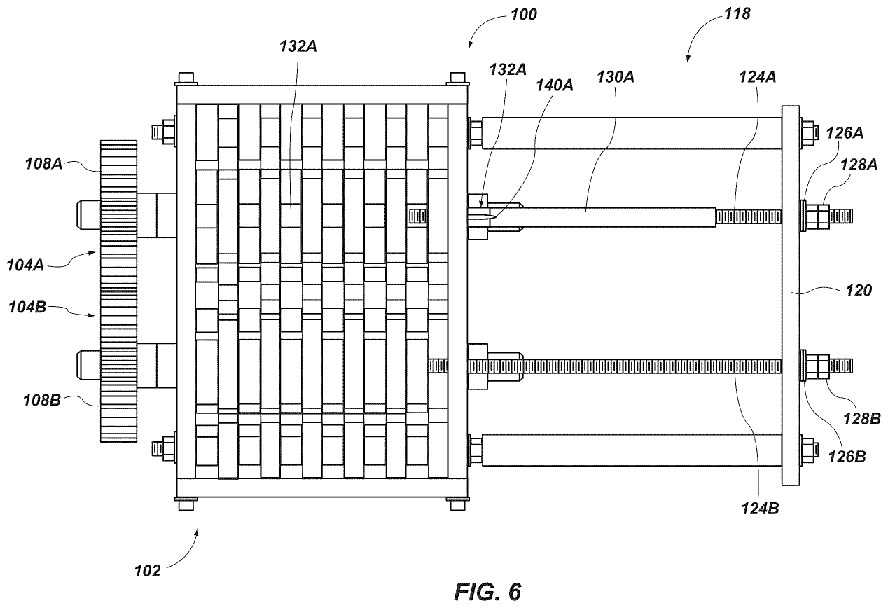

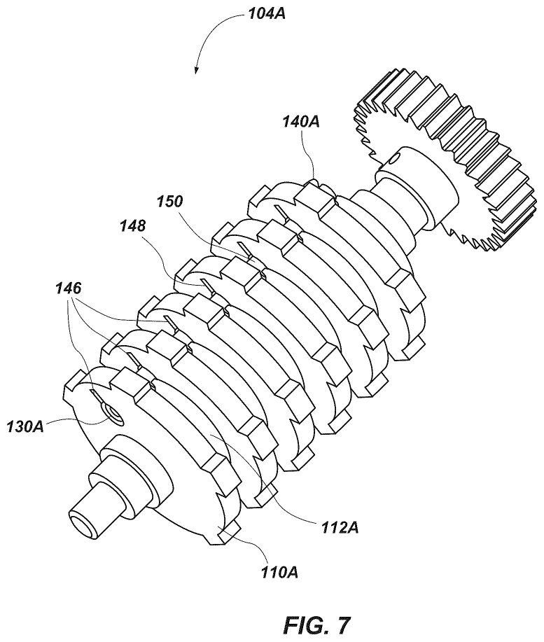

Referring to FIGS. 5 and 6, the roller assembly 104A, 104B includes a cutter recess 132A, 132B defined in the shredder disks 110A, 110B and the roller spacers 112A, 112B. The cutter recess 132A, 132B may include grooves (e.g., openings) extending axially through each of the roller disks (e.g., shredder disks 110A, 110B and roller spacers 112A, 112B). The grooves in the roller disks may be aligned both axially and angularly to form a linear path through each roller assembly 104A, 104B. In some embodiments, the cutter recess 132A, 132B defines a parallel path positioned radially outward from a rotational axis of the roller assembly 104A, 104B. In some embodiments, the cutter recess 132A, 132B extends radially through an entire width of the shredder disks 110A, 110B and the roller spacers 112A, 112B. In some embodiments, the cutter recess 132A, 132B does not intersect with the rotational axis of the roller assembly 104A, 104B. The cutter recess 132A, 132B is configured to receive a cutter assembly 134A, 134B. The cutter assembly 134A, 134B includes cutter shaft 130A, 130B and cutter blade 140A, 140B (shown in FIG. 7). During operation of the shredder assembly 100, the cutter assembly 134A, 134B may be housed within the cutter recess 132A, 132B and may rotate with the roller assembly 104A, 104B relative to the shredder frame 102. The cutter assembly 134A, 134B may be integrated into portions of the roller assembly 104A, 104B that rotate during use and operation of the shredder assembly 100.

Referring to FIGS. 5 and 6, as solid waste is processed by the shredder assembly 100 during operation, FPP or other flexible materials present in the solid waste may become wrapped around and accumulate on the roller assembly 104A, 104B. As FPP or other flexible materials accumulate on the roller assembly 104A, 104B, performance of the shredder assembly 100 degrades. The shredder assembly 100 may then be shut down to stop the roller assembly 104A, 104B from rotating.

As shown in FIGS. 5 and 6, the cutter assemblies 134A, 134B may be moved across the roller assemblies 104A, 104B from a stored position to an extended position to cut away accumulated FPP or other flexible materials. After removal of the FPP or other flexible materials from the roller assemblies 104A, 104B, the cutter assemblies 134A, 134B may then be returned from the extended position to the stored position and operation of the shredder assembly 100 may continue. For example, FIG. 5 illustrates the cutter assembly 134A in a stored position and the cutter assembly 134B in the extended position. FIG. 6 illustrates the cutter assembly 134A in the extended position and the cutter assembly 134B in the stored position.

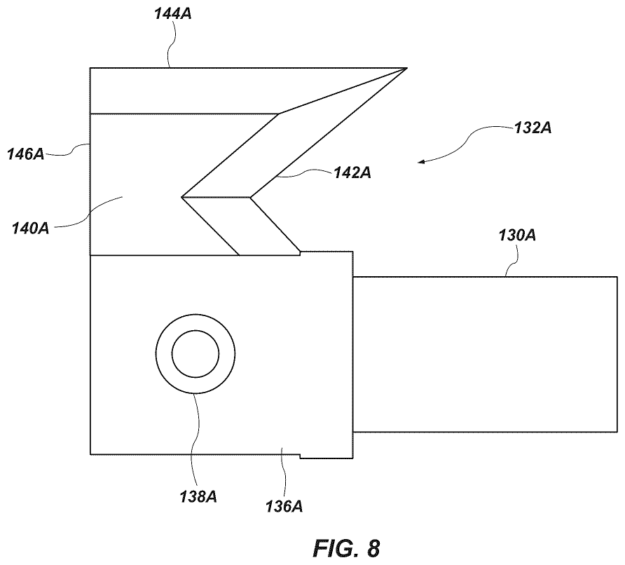

To move the cutter assemblies 134A, 134B from the stored position to the extended position, personnel may insert the retrieval rods 124A, 124B through a hole defined by the shredder frame 102 to couple the retrieval rods 124A, 124B with the associated cutter shaft 130A, 130B. The personnel may then couple a tool to the rod coupling 128A, 128B and rotate the associated retrieval rod 124A, 124B (e.g., in a clockwise direction) to translate the associated cutter assembly 134A, 134B across the roller assembly 104A, 104B through the associated cutter recess 132A, 132B in a direction parallel to the axis of rotation of the roller assembly 104A, 104B. In some embodiments, the retrieval rod 124A, 124B is inserted and rotated automatically, such as through the use of an electric motor, electric solenoid, or by hydraulic or pneumatic mechanisms. As the cutter assembly 134A, 134B is moved across the associated roller assembly 104A, 104B, from the stored position to the extended position the cutter blade 140A, 140B (shown in FIG. 8) of the cutter assembly 134A, 134B may cut (e.g., loosen) the accumulated FPP or other flexible materials from the roller assembly 104A, 104B. In some embodiments, the cutter assemblies 134A, 134B may be completely removed from the roller assemblies 104A, 104B in the extended position. The personnel may then use the tool coupled to the rod coupling 128A, 128B to rotate the retrieval rod 124A, 124B in an opposite direction (e.g., counter-clockwise) to insert cutter assembly 134A, 134B back through the cutter recess 132A, 132B from the extended position back to the stored position and operation of the shredder assembly 100 may continue.

As illustrated in FIGS. 1-6, the retrieval rods 124A, 124B includes external threads configured to couple (e.g., selectively couple) to internal threads of the cutter shafts 130A, 130B. Other embodiments may include different combinations of methods, devices, or fasteners to selectively couple the retrieval rods 124A, 124B to the cutter shafts 130A, 130B, such as quick connect fittings, magnetic fittings, and push-push latch mechanisms. When the external threads of one of the retrieval rods 124A, 124B are coupled to the internal threads of the associated cutter shaft 130A, 130B, a user of the shredder assembly 100 may continue to rotate the associated retrieval rod 124A, 124B to translate the cutter assembly 134A, 134B across the associated roller assembly 104A, 104B. The rod couplings 128A, 128B may be configured as hardware fasteners, such as hex nuts, which may be engaged by a tool, such as a power drill, hand drill, hex socket, or other hand tool. The tool may be operated by the user or other automated control mechanism, such as a robot, to rotate the retrieval rods 124A, 124B. As one of the retrieval rods 124A, 124B rotate, the associated rod abutment 126A, 126B engages the extension plate 120 to prevent movement of the retrieval rod 124A, 124B along the axis of the retrieval rod 124A, 124B.

FIG. 7 illustrates a perspective view of the roller assembly 104A of the shredder assembly 100. The roller assembly 104B is complementary to the roller assembly 104B and may include substantially the same elements and features. Thus, while FIG. 7 illustrates the roller assembly 104A and the associated description is directed to the roller assembly 104A, the same features and elements may also be included on roller assembly 104B.

The shredder disks 110A of the roller assembly 104A may include grooves 146 extending through each of the shredder disks 110A. The grooves 146 may be configured to facilitate the cutter blade 140A passing through the shredder disks 110A as the cutter shaft 130A pulls the cutter assembly 134A from the stored position to the extended position. The grooves 146 include a slot 148 configured to receive the cutter blade 140A, as the cutter blade 140A passes through the associated shredder disk 110A. The grooves 146 also include a larger circular aperture 150 configured to house the cutter shaft 130A.

As the cutter blade 140A passes into the slot 148 of an associated groove, the interface between the cutter blade 140A and the slot 148 may create a shearing effect to cut any FPP captured by the cutter blade 140A as the cutter blade 140A passes through an adjacent space defined between the shredder disks 110A by the roller spacers 112A. In some embodiments, the cutter blade 140A is positioned within one of the slots 148 in one of the shredder disks 110A when in the stored position.

FIG. 8 illustrates an enlarged view of the cutter assembly 134A. The cutter assembly 134B is substantially the same as the cutter assembly 134A and may include substantially the same elements and features. Thus, while FIG. 8 illustrates the cutter assembly 134A and the associated description is directed to the cutter assembly 134A, the same features and elements may also be included on cutter assembly 134B.

The cutter assembly 134A includes the cutter shaft 130A, the cutter blade 140A and a blade coupler 136A. The blade coupler 136A is configured to couple the cutter blade 140A to the cutter shaft 130A. In some embodiments, the blade coupler 136A is configured as a sleeve and sized to slide over the cutter shaft 130A. The position of the blade coupler 136A may then be fixed relative to the cutter shaft 130A by tightening a blade fastener 138A. As illustrated in FIG. 8, the blade fastener 138A is illustrated as a set screw. In other embodiments, the blade fastener 138A may include a pin or a clamp. In other embodiments, the blade coupler 136A may be coupled to the cutter shaft 130A through an interference fit, through an adhesive, or through a welded connection. In some embodiments, the blade fastener 138A couples the cutter blade 140A to the blade coupler 136A. In some embodiments, the blade coupler 136A, the blade 140A, the cutter shaft 130A, or any combination thereof may be integrally formed of a monolithic piece of material.

Movement of the cutter assembly 134A across the roller assembly 104A may be driven by the activation of the movement mechanism. Embodiments of movement mechanisms include different combinations of methods, devices, or fasteners to selectively move the cutter assembly 134A relative to the roller assembly 104A, such as the retrieval rod 124A, a worm gear, hydraulic or pneumatic mechanisms, or a cam.

The cutter blade 140A may include an arcuate (e.g., a gut-hook style) front edge 142A, a straight front edge 142A, a concave front edge 142A, a convex front edge 142A, a serrated front edge 142A, or a front edge 142A with multiple cutting portions intersecting at one or more focal points for cutting. A concave curved front edge 142A or a front edge 142A with one or more straight cutting portions intersecting at one or more focal points may help to prevent FPP or other flexible materials from slipping over a the top edge 144A of the cutter blade 140A. Like the front edge 142A, the top edge 144A may include an arcuate (e.g., a gut-hook style) top edge 144A, a straight top edge 144A, a concave top edge 144A, a convex top edge 144A, a serrated top edge 144A, or a top edge 144A with multiple cutting portions intersecting at one or more focal points for cutting. In some embodiments, the cutter blade 140A includes a sharpened back edge 146A opposite the front edge 142A configured to cut FPP or other flexible materials as the cutter assembly 134A is moved in the opposite direction. Like the front edge 142A, the back edge may be an arcuate (e.g., a gut-hook style) back edge 146A, a straight back edge 146A, a concave back edge 146A, a convex back edge 146A, a serrated back edge 146A, or a back edge 146A with multiple straight cutting portions intersecting at one or more focal points for cutting. The blade 140A may include a sharpened front edge 142A, a sharpened top edge 144A, a sharpened back edge 146A, or any combination thereof. In some embodiments, a leading point of the front edge 142A extends axially beyond a connected portion of the cutter blade 140A at the blade coupler 136A. In some embodiments, the blade 140A is aligned with the roller spacer 112A while the cutter assembly 134A is in the stored position to facilitate cutting of waste materials by the top edge 144A during operation of the shredder assembly 100.

In some embodiments, the cutter assembly 134A, 134B includes cutter blades 140A, 140B coupled to the cutter shaft 130A, 130B. In embodiments where a single cutter blade 140A, 140B is coupled to the cutter shaft 130A, 130B the cutter assembly 134A, 134B may travel substantially the entire length of the roller assembly 104A, 104B to remove the accumulated FPP or other flexible materials from the roller assembly 104A, 104B. By including multiple cutter blades 140A, 140B coupled to the cutter shaft 130A, 130B the distance the cutter assembly 134A, 134B travels to remove the FPP or other flexible materials may be reduced. For example, by including two cutter blades 140A, 140B coupled to the cutter shaft 130A, 130B the travel distance may be decreased by half. In some embodiments, the number of cutter blades 140A, 140B may be equal to or substantially equal (e.g., a difference of plus or minus one or two) to the number of shredder disks 110A, 110B and/or roller spacers 112A, 112B. Each cutter blade 140A, 140B may be configured to translate a predetermined distance. For example, each cutter blade 140A, 140B may be configured to translate the width of a shredder disk 110A, 110B, the width of a roller spacer 112A, 112B, or the width of a shredder disk 110A, 110B and a roller spacer 112A, 112B.

In some embodiments, a cam is operably coupled to the cutter assemblies 134A, 134B and configured to oscillate the cutter assemblies 134A, 134B (e.g., translate each cutter assembly 134A, 134B back and forth in a direction parallel to the roller assembly 104A, 104B) as the roller assemblies 104A, 104B are rotated during operation of the shredder assembly 100. In some embodiments, the cam is coupled to the shredder frame 102 and configured to operably contact the cutter assemblies 134A, 134B as the roller assemblies 104A, 104B are rotated with respect to the shredder frame 102. Thus, the cutter assemblies 134A, 134B may function to remove FPP or other flexible materials during operation of the shredder assembly 100 without shutting down the equipment. In some embodiments, the cutter assemblies 134A, 134B may be configured to oscillate back and forth once per revolution of the associated roller assembly 104A, 104B. In other embodiments, the cutter assemblies 134A, 134B may be configured to oscillate multiple times per revolution of the associated roller assembly 104A, 104B. In other embodiments, the cutter assemblies 134A, 134B may be configured to rotate back and forth once over the course of multiple revolutions of the associated roller assembly 104A, 104B.

Some embodiments include the cutter blade 140A, 140B positioned along substantially the entire length of the cutter shaft 130A, 130B. The cutter shaft 130A, 130B may be configured to translate from the stored position in a radially outward direction of the roller assembly 104A, 104B to a radially extended position to cut through the accumulated FPP or other flexible materials. Upon removal of the accumulated FPP or other flexible materials, the cutter shaft 130A, 130B may then be translated radially inward from the radially extended position to the stored position within the cutter recess 132A, 132B. In some embodiments, the cutter shaft 130A, 130B includes multiple cutter blades 140A, 140B aligned axially with each of the roller spacers 112A, 112B. The cutter blades 140A, 140B may include a concave (e.g., gut-hook style) top edge 144A (as described in reference to FIG. 8). The roller assembly 104A, 104B may include a cam which translates the cutter shaft 130A, 130B in a radially outward direction with respect to the roller assembly 104A, 104B as the roller assembly 104A, 104B rotates during normal operation of the shredder assembly 100. In some embodiments, the shredder assembly 100 is shut down, and the cutter assembly 134A, 134B is translated radially outward during downtime to cut any material wrapped around the roller assembly 104A, 104B, and then the cutter assembly 134A, 134B may be reinserted prior to operating the waste processing equipment again.

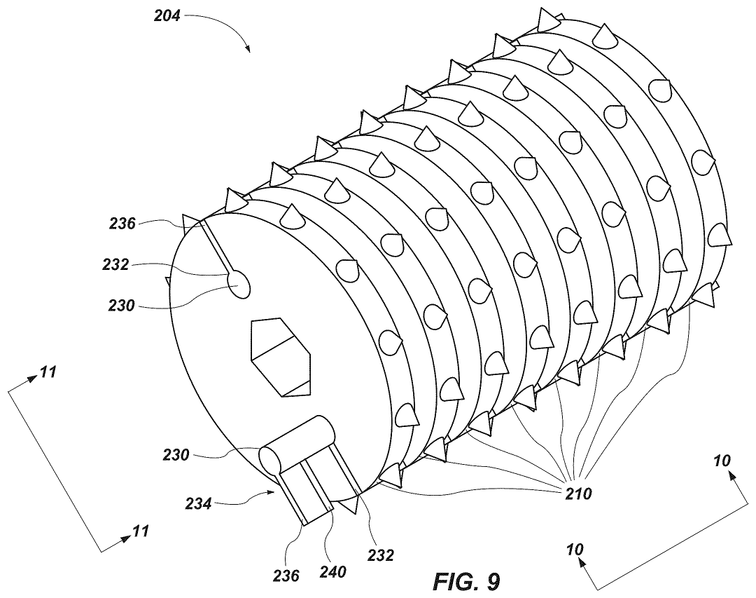

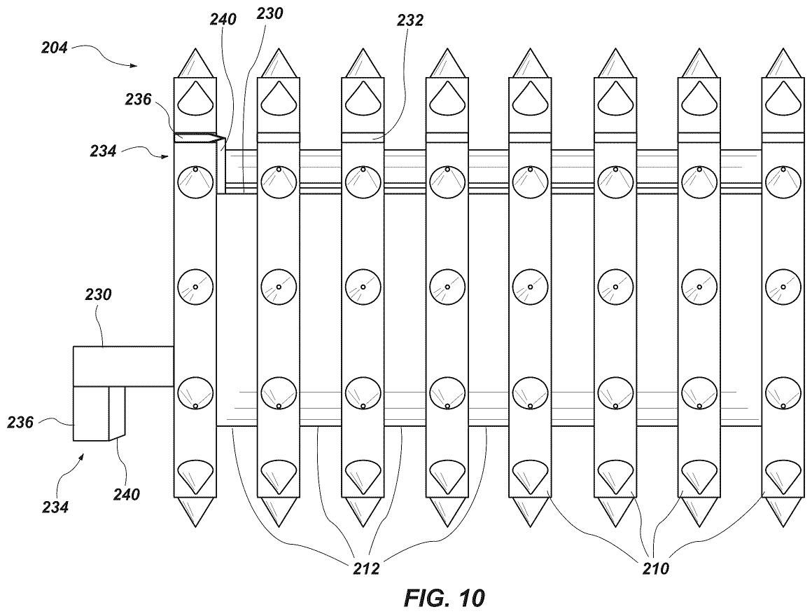

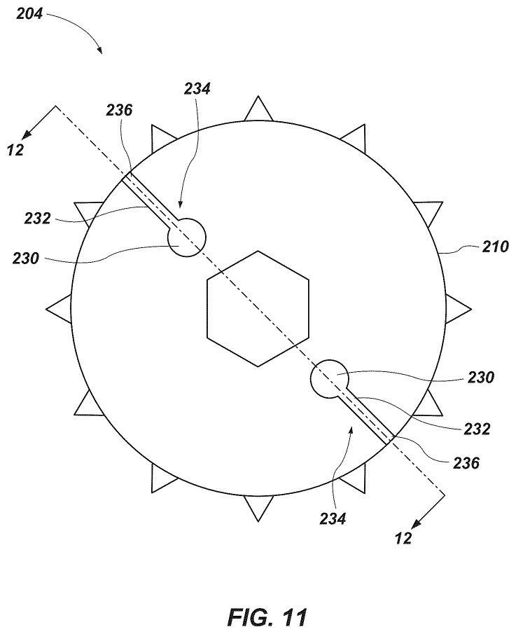

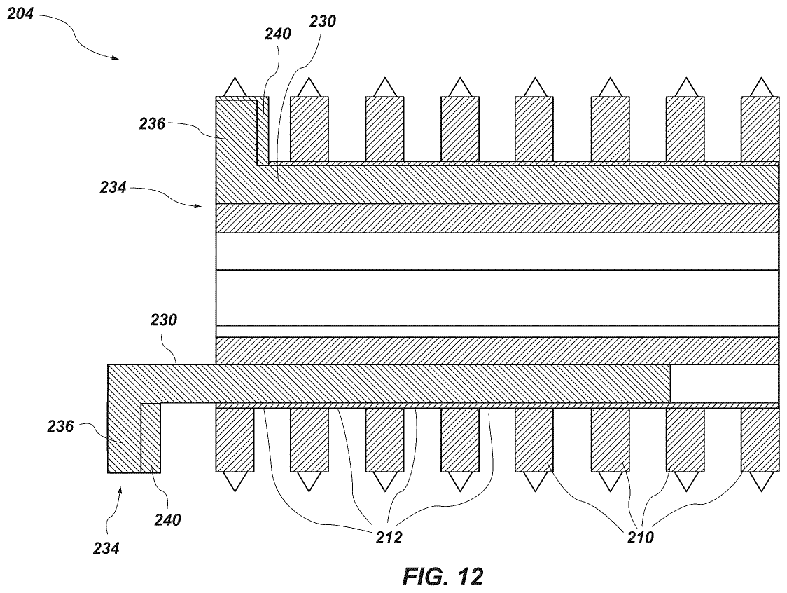

FIGS. 9 through 12 illustrate an exemplary roller assembly 204 with an integrated cutter assembly 234 according to one or more embodiments. The roller assembly 204 includes a plurality of shredder disks 210 interspaced with a plurality of roller spacers 212. The plurality of shredder disks 210 and roller spacers 212 define a cutter recess 232 configured to receive a cutter assembly 234. The cutter assembly 234 includes a cutter shaft 230, blade coupler 236, and a cutter blade 240. The cutter blade 240 may be removably coupled to the blade coupler 236. Accordingly, the cutter blade 240 may be replaced or repaired periodically as is necessary. The cutter shaft 230, the blade coupler 236, the cutter blade 240, or any combination thereof may be integrally formed from a monolithic piece of material.

The shredder disks 210 of a first roller assembly 204 may be configured to axially align with the spacers 212 of a second roller assembly (not shown) such that the shredder disks 210 of the first roller assembly 204 are interspaced with the shredder disks 210 of the second roller assembly 204. Additionally, the first roller assembly 204 may be positioned with the second roller assembly 204 such that the shredder disks 210 of the first roller assembly 204 overlap in a radially outward direction with the shredder disks 210 of the second roller assembly 204.

The cutter recess 232 defined in the shredder disks 210 and the roller spacers 212 may include grooves or openings extending axially through each of the shredder disks 210 and the roller spacers 212. The grooves or openings in the shredder disks 210 and the roller spacers 212 may be aligned both axially and angularly to form a linear path through each roller assembly 204. The cutter recess 232 is configured to receive the cutter assembly 234. During operation of the roller assembly 204 the cutter assembly 234 may be housed within the cutter recess 232 and may rotate with the roller assembly 204.

As FPP or other flexible materials accumulate on the roller assembly 204, performance of the roller assembly 204 degrades. The cutter assembly 234 may be moved across the roller assembly 204 through the cutter recess 232 in a direction parallel to the axis of rotation of the roller assembly 204. As the cutter assembly 234 is pulled across the roller assembly 204, the cutter blade 240 of the cutter assembly 234 cuts the accumulated FPP or other flexible materials loose from the roller assembly 204. The cutter assembly 234 may then be inserted back through the cutter recess 232 and operation of the roller assembly 204 may continue.

The cutter assembly 234 includes the cutter shaft 230, the cutter blade 240 and a blade coupler 236. The blade coupler 236 is configured to couple the blade 240 to the cutter shaft 230. As illustrated in FIGS. 9 through 12, the blade coupler 236 and the cutter shaft 230 are formed integrally from a monolithic piece of material. In some embodiments, the cutter shaft 230, the cutter blade 240, the blade coupler 236, or any combination thereof may be formed integrally from a monolithic piece of material or may be formed as separate parts and coupled together. In some embodiments, the blade coupler 236 is configured as a sleeve and sized to slide over the cutter shaft 230. The position of the blade coupler 236 may then be fixed relative to the cutter shaft 230 by tightening a blade fastener. The blade fastener may be a set screw, a pin, or a clamp. In some embodiments, the blade coupler 236 may be coupled to the cutter shaft 230 through an interference fit, through an adhesive, or through a welded connection.

The cutter blade 240 may include an arcuate (e.g., a gut-hook style) front edge, a straight front edge, a concave front edge, a convex front edge, a serrated front edge, or a front edge with multiple straight cutting portions intersecting at one or more focal points for cutting. A concave curved front edge or a front edge with one or more straight cutting portions intersecting at one or more focal points may help to prevent FPP or other flexible materials from slipping over a the top edge of the cutter blade 240. The top edge may include an arcuate (e.g., a gut-hook style) top edge, a straight top edge, a concave top edge, a convex top edge, a serrated top edge, or a top edge with multiple straight cutting portions intersecting at one or more focal points for cutting. In some embodiments, the cutter blade 240 includes a sharpened back edge opposite the front edge configured to cut FPP or other flexible materials as the cutter assembly 234 is moved in the opposite direction. Like the front edge, the back edge may be an arcuate (e.g., a gut-hook style) back edge, a straight back edge, a convex back edge, a serrated back edge, or a back edge with multiple straight cutting portions intersecting at one or more focal points for cutting. The blade 240 may include a sharpened front edge, a sharpened top edge, a sharpened back edge, or any combination thereof. In some embodiments, a leading point of the front edge extends axially beyond a connected portion of the cutter blade 240 at the blade coupler 236. In some embodiments, the blade 240 is aligned with the roller spacer 212 while the cutter assembly 234 is in the stowed position to facilitate cutting of waste materials by the top edge during operation of the roller assembly 204.

In some embodiments, the cutter assembly 234 includes multiple blade couplers 236 and multiple cutter blades 240 coupled to the cutter shaft 230. Multiple cutter blades 240 coupled to the cutter shaft 230 may allow for the accumulated FPP or other flexible materials to be removed from substantially the entire length of the roller assembly 204 with a shorter length of translation of the cutter assembly 234. In some embodiments, the number for cutter blades 240 may be equal to or substantially equal (e.g., a difference of plus or minus one or two) to the number of shredder disks 210 and/or roller spacers 212. Each cutter blade 240 may be configured to translate a predetermined distance. For example, each cutter blade 240 may be configured to translate the width of a shredder disk 210, the width of a roller spacer 212, or the width of a shredder disk 210 and a roller spacer 212.

Movement of the cutter assembly 234 across the roller assembly 204 may be driven by the activation of a movement mechanism. Embodiments of movement mechanisms include different combinations of methods, devices, or fasteners to selectively move the cutter assembly 234 relative to the roller assembly 204, such as a retrieval rod substantially similar to the retrieval rod 124A, 124B as described in reference to the embodiments of FIGS. 1-6, a worm gear, hydraulic or pneumatic mechanisms, or a cam.

In some embodiments, a cam is operably coupled to the cutter assembly 234 and configured to oscillate the cutter assembly 234 (e.g., translate the cutter assembly 234 back and forth in a direction parallel to the roller assembly 204) as the roller assembly 204 is rotated during operation. In some embodiments, the cam is coupled to the waste processing equipment and configured to operably contact the cutter assembly 234 as the roller assembly 204 is rotated during use. Thus, the cutter assembly 234 may function to remove FPP or other flexible materials during operation of the roller assembly 204 without the need for an equipment shutdown. In some embodiments, the cutter assembly 234 may be configured to oscillate back and forth once per revolution of the roller assembly 204. In other embodiments, the cutter assembly 234 may be configured to oscillate multiple times per revolution of the roller assembly 204. In other embodiments, the cutter assembly 234 may be configured to rotate back and forth once over the course of multiple revolutions of the roller assembly 204.

Some embodiments include a cutter blade 240 positioned substantially along the entire length of the cutter shaft 230. The cutter shaft 230 may be configured to translate in a radially outward direction of the roller assembly 204. To cut through the accumulated FPP or other flexible materials. Upon removal of the accumulated FPP or other flexible materials the cutter shaft 230 may then be translated radially inward into a stored position within the cutter recess 232. In some embodiments, the cutter shaft 230 includes multiple cutter blades 240 aligned axially with each of the roller spacers 212. The cutter blades 240 may include a concave (e.g., gut-hook style) top edge 144A (as described in reference to FIG. 8). The roller assembly 204 may include a cam which translates the cutter shaft 230 in a radially outward direction with respect to the roller assembly 204 as the roller assembly 204 rotates during normal operation. In some embodiments, the roller assembly 204 is shut down, and the cutter assembly 234 is translated radially outward during downtime to cut any material wrapped around the roller assembly 204, and then the cutter assembly 234 reinserted prior to operating the waste processing equipment again.

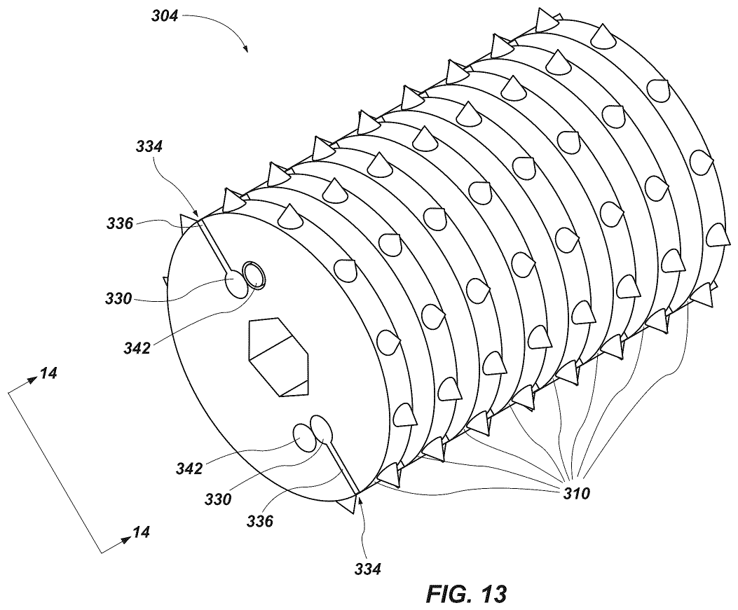

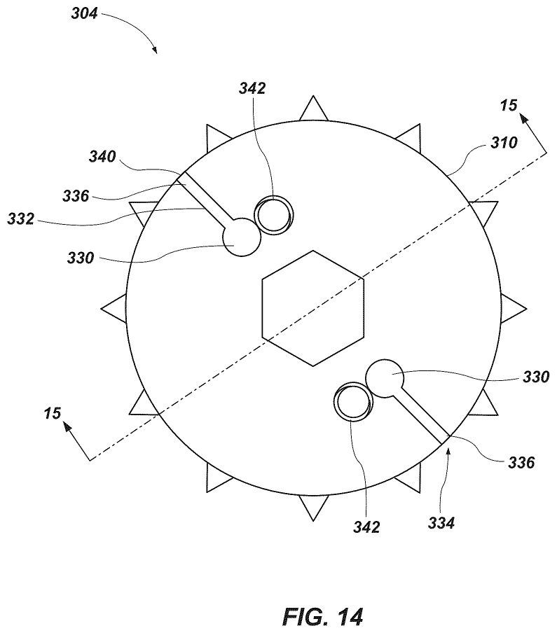

Referring now to FIGS. 13 through 16, roller assembly 304 may include both a cutter assembly 334 and a moving mechanism (e.g., a worm gear 342) integrated within the roller assembly 304. Roller assembly 304 includes a plurality of shredder disks 310 interspaced with a plurality of roller spacers 312. The plurality of shredder disks 310 and roller spacers 312 define a cutter recess 332 configured to receive cutter assembly 334. Cutter assembly 334 includes a cutter shaft 330, blade support 336, and cutter blade 340.

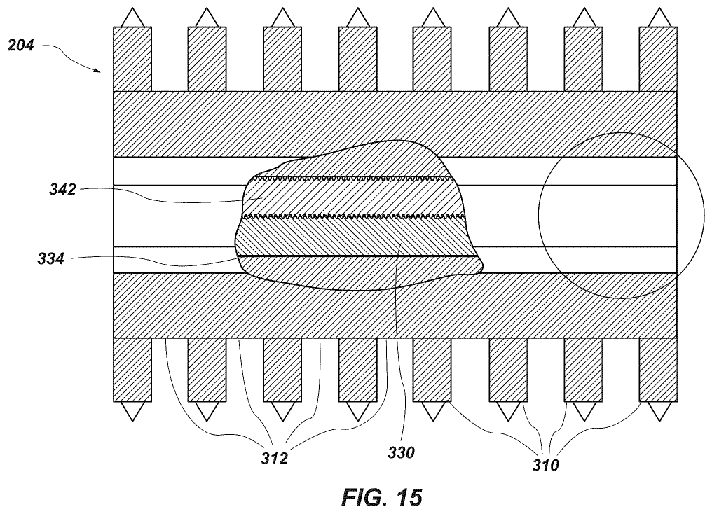

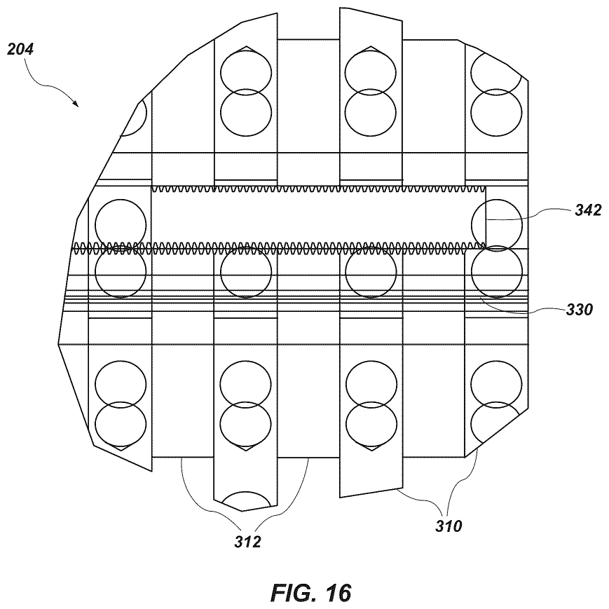

The cutter shaft 330 and the worm gear 342 include external threading (as shown in greater detail in FIGS. 15 and 16). The external threading of the worm gear 342 is configured to engage with the external threading of the cutter shaft 330. The worm gear 342 includes an external portion accessible from an opening defined by a shredder disk 310 located on a distal portion of the roller assembly 304. The external portion of the worm gear 342 may include at least one coupling feature to couple the worm gear 342 to one or more driving mechanisms. Personnel may couple a driving mechanism (e.g., a tool) to the external portion of the worm gear 342 to rotate or turn the worm gear 342. For example, the driving mechanism may include, but is not limited to, a screwdriver, handheld drill, or other tool for rotating the worm gear 342. The coupling feature may include, but is not limited to a hex (e.g., ALLEN™) socket, a star (e.g., TORX™) socket, a Phillips socket, a slotted head, or a Robertson head. In other embodiments, the driving mechanism may be directly coupled to a motor or other piece of equipment configured to drive the worm gear 342 based on signals from a controller or sensor. For example, a controller may be configured to send a signal to have the motor drive the worm gear at specific intervals (e.g., one per revolution of the roller assembly 304 or specific time intervals), whenever the associated roller assembly 304 stops, when FPP is detected, or when an operator send a manual signal.

As the worm gear 342 is rotated (e.g., in a clockwise direction), the external threads of the worm gear 342 engage with the external threads of the cutter shaft 330 and drive the lateral movement of the cutter assembly 334 from a stored position across the roller assembly 304 in a direction parallel to the rotational axis of the roller assembly 304 to an extended position. As the cutter assembly 334 moves across the roller assembly 304, the cutter blade 340 cuts through any FPP or other flexible materials which have accumulated on the roller assembly 304 facilitating the removal of the FPP or other flexible materials from the roller assembly 304. After the cutter assembly 334 has moved across the desired length of the roller assembly 304, the direction of the rotation of the worm gear 342 may be reversed, to move the cutter assembly 334 in the opposite direction from the extended position until the cutter assembly 334 has returned to its original stored position.

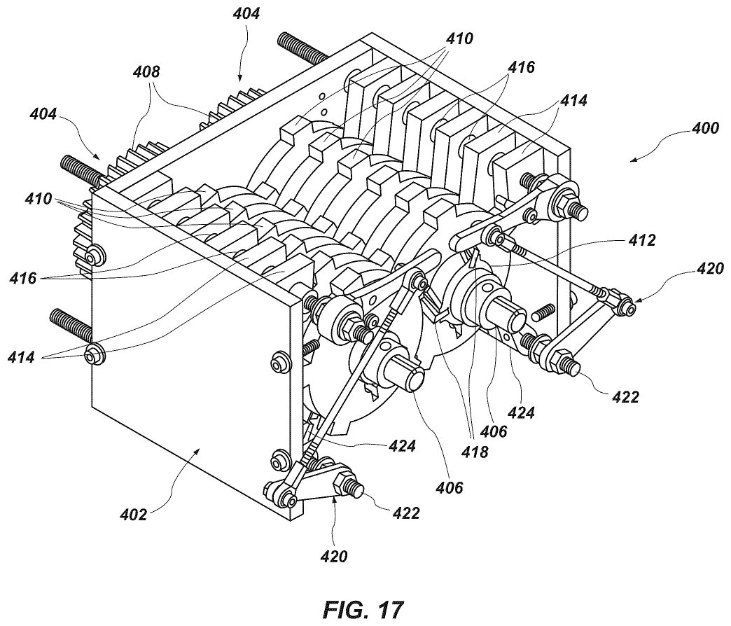

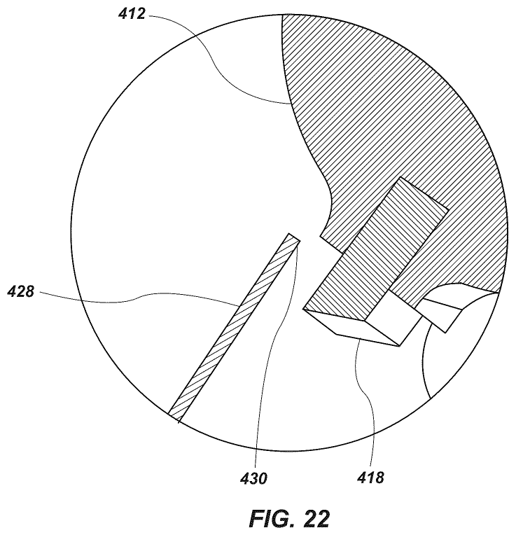

In some embodiments, as illustrated in FIGS. 17 through 22, a shredder assembly 400 may include at least one first shearing element and at least one second shearing element configured to cut FPP or other flexible materials as the first shearing element contacts the second shearing element. In some embodiments, the first shearing element is a shear blade 418 and the second shearing element is a shearing surface 430 of a spring tab 428. The shearing surface 430 may be configured to contact the shear blade 418 during operation of the shredder assembly 400 to cut and remove FPP or other flexible materials from roller assembly 404. The shredder assembly 400 includes a shredder frame 402. In FIGS. 17 through 22, a front wall of the shredder frame 402 is removed for illustrative purposes. The shredder assembly 400 includes at least one roller assembly 404 coupled to and supported by the shredder frame 402. The roller assembly 404 includes a roller shaft 406, roller gears 408 configured to transfer mechanical force to rotate the roller assembly 404, and a plurality of shredder disks 410 interspaced with roller spacers 412. The shredder assembly 400 also includes a plurality of side plates 414 and side spacers 416 coupled to the shredder frame 402. The side plates 414 are configured to mesh with the shredder disks 410 of the roller assembly 404.

In some embodiments, as illustrated in FIGS. 17 through 22, the roller spacers 412 include at least one shear blade 418 coupled to the roller spacer 412. In some embodiments, the shear blade 418 is removably coupled to the roller spacer 412 such that the shear blade 418 may be replaced as needed for maintenance of the shredder assembly 400. The shredder assembly 400 includes a movement mechanism including a linkage assembly 420. The linkage assembly 420 configured to selectively rotate a cutter assembly 424. Cutter assembly 424 includes an engagement shaft 422, spring tab support 426, and spring tab 428. The linkage assembly 420 may be selectively activated to move the cutter assembly 424 between an engaged position and a disengaged position. In some embodiments, as illustrated in FIGS. 17-22, the cutter assembly 424 is configured to rotate between the engaged position and the disengaged position. In other embodiments, the cutter assembly 142 may be configured to move linearly between the engaged position and the disengaged position, such as through a telescoping linkage, on a hydraulic ram, or through a rack and pinion connection.

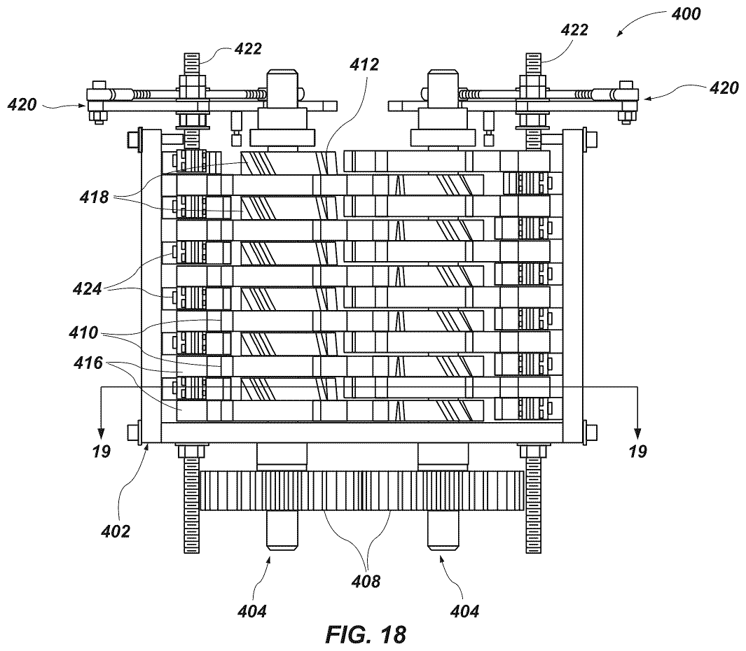

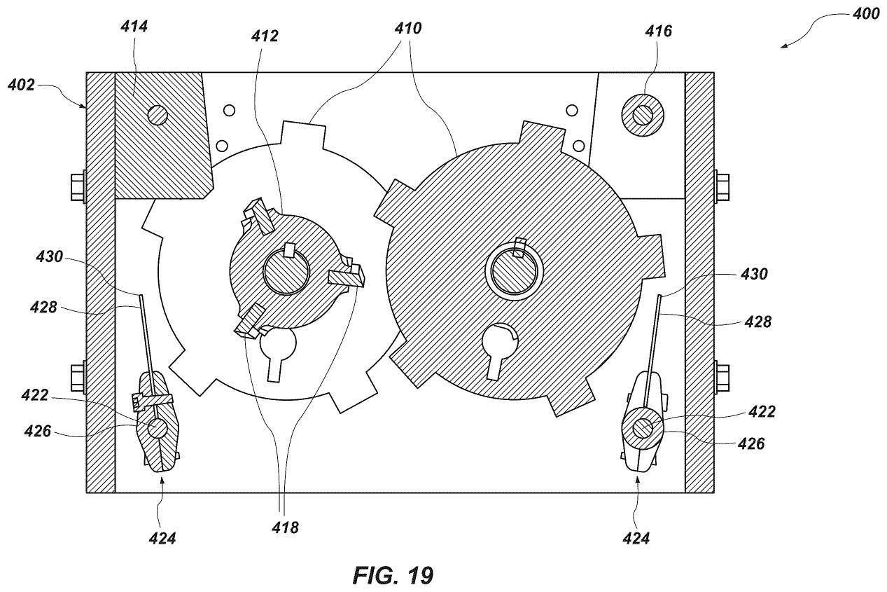

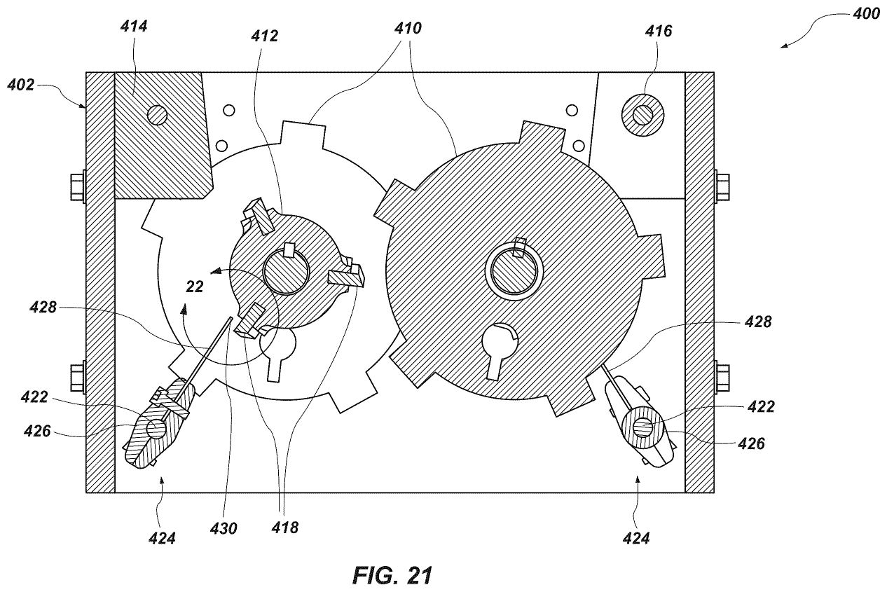

Referring now to FIGS. 18 through 21, the spring tab support 426 couples at least one spring tab 428 to the engagement shaft 422. In the embodiments illustrated in FIGS. 19 and 21, the spring tab support 426 is a clamp. In other embodiments, the spring tab support 426 may include, but are not limited to press fittings, keyways, threaded fixtures, and welded fixtures. In some embodiments, the spring tab 428 is removably coupled to the spring tab support 426 such that the spring tab 428 may be replaced as needed for maintenance of the shredder assembly 400. In other embodiments, the spring tab 428, the spring tab support 426, the engagement shaft 422, or any combination thereof are integrally formed from a monolithic piece of material.

FIGS. 18 and 19 illustrate the shredder assembly 400 with the engagement shaft 422 rotated to the disengaged position. When in the disengaged position, the engagement shaft 422 rotates the spring tabs 428 away from the shear blades 418 to facilitate operation of the shredder assembly 400 by defining a space between the spring tabs 428 and the shear blades 418. As FPP or other flexible materials accumulate on the roller assembly 404 during usage, the linkage assembly 420 is activated to rotate the engagement shaft 422 from the disengaged position to the engaged position.

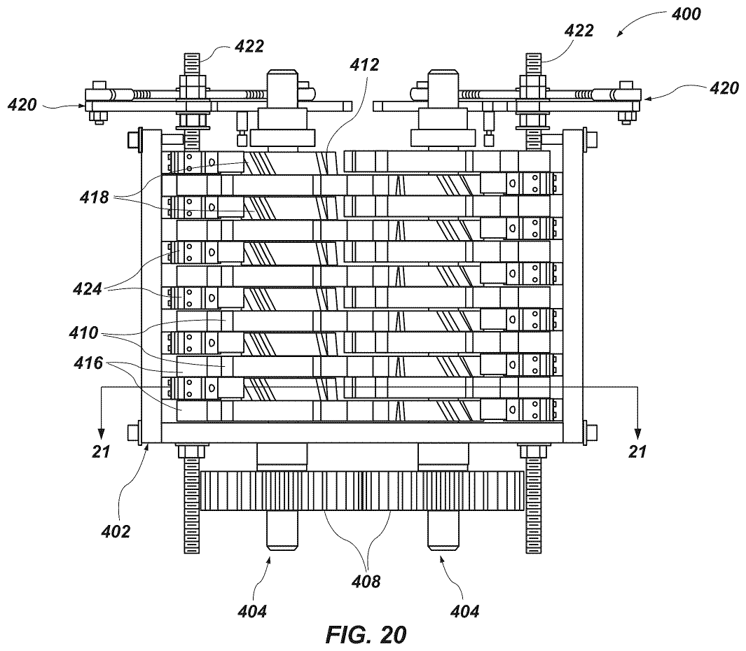

Referring now to FIGS. 20 through 22, the engagement shaft 422 is depicted in the engaged position. In the engaged position, a shearing surface 430 of the at least one spring tab 428 is positioned to engage with the at least one shear blade 418 during rotation of the roller assembly 404. As the shear blade 418 contacts and slides past the shearing surface 430 of the spring tab 428, the shear blade 418 and the shearing surface 430 function together to cut accumulated FPP or other flexible materials from the roller assembly 404. In some embodiments, a cutting edge of the shear blade 418 or a distal edge of the spring tab 428 is angled such that the shear blade 418 is configured to contact the shearing surface 430 of the spring tab 428 at a desired focal point. Maintaining the contact between the shear blade 418 and the spring tab 428 may help to cut the accumulated FPP or other flexible materials and prevent slippage of the FPP or other flexible materials between the spring tab 428 and the shear blade 418. However, the cutting edge of shear blade 418 may be configured parallel to the shearing surface 430 of the spring tab 428 such that substantially all of the cutting edge of the shear blade 418 contacts substantially all of the shearing surface 430 of the spring tab 428 simultaneously. During operation of the shredder assembly 400 with the engagement shaft 422 in the engaged position, some of the accumulated FPP or other flexible materials may pass between the spring tab 428 and the shear blade 418 without being cut. Accordingly, the engagement shaft 422 may be maintained in the engaged position for a desired time, for a desired number of rotations of the roller assembly 404, or as needed (e.g., as determined by a user of the shredder assembly 400) to remove substantially all the accumulated FPP or other flexible materials.

The linkage assembly 420 may be activated to rotate the engagement shaft 422 from the disengaged position to an engaged position and back to the disengaged position during normal operation of the shredder assembly 400 to allow for the accumulated FPP or other flexible materials to be removed from the shredder assembly 400 without the need for an equipment shutdown. The linkage assembly 420 may be activated manually by the user. In some embodiments, the linkage assembly 420 is activated automatically using an electric motor or by mechanical means (e.g., mechanical linkages or gears coupled to the roller assembly 404). In some embodiments, the engagement shaft 422 may be rotated to the engaged position upon in timed intervals or by detection (e.g., via one or more sensors) of the accumulation of FPP or other flexible materials.

Embodiments of the disclosure include blades or shears configured to remove flexible materials, such as FPP or other flexible materials from rotating components. The apparatus and method as described herein may facilitate the mechanical removal of FPP or other flexible materials from rotating parts of municipal solid waste processing equipment. The use of the disclosed apparatus and method may reduce equipment maintenance time and remove humans from this dangerous environment. Accordingly, solid waste may be processed more efficiently, faster, and in a safer work environment.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. An apparatus for removing flexible material from rotating equipment comprising:
a roller assembly comprising a cutter recess defined in one or more components of the roller assembly, the cutter recess extending radially toward a rotational axis of the roller assembly;
a cutter assembly operable between a stored position within the cutter recess and an extended position, the cutter assembly comprising:
a cutter shaft;
a cutter blade coupled to the cutter shaft; and
a movement mechanism configured to move the cutter assembly parallel to the rotational axis of the roller assembly to cut accumulated material from the roller assembly.

2. The apparatus of claim 1, wherein the cutter blade comprises a concave cutting edge.

3. The apparatus of claim 1, wherein at least a portion of the cutter recess is defined in one or more shredding disks.

4. The apparatus of claim 3, wherein the cutter shaft is rotationally fixed with respect to the roller assembly.

5. The apparatus of claim 1, wherein the movement mechanism comprises a worm gear.

6. The apparatus of claim 1, wherein the movement mechanism comprises a cam.

7. The apparatus of claim 1, wherein the movement mechanism is configured to move the cutter assembly relative to the rotating equipment and return the cutter assembly to the stored position.

8. An apparatus configured to remove flexible material from rotating equipment, the apparatus comprising:
a roller assembly positioned within a frame;
at least one first shearing element extending radially from the roller assembly; and
at least one second shearing element secured to the frame and configured to contact the at least one first shearing element extending radially from the roller assembly.

9. The apparatus of claim 8, wherein the at least one second shearing element is configured to rotate relative to the frame between an engaged position and a disengaged position.

10. The apparatus of claim 9, wherein the at least one second shearing element is configured to contact with the at least one first shearing element in the engaged position.

11. The apparatus of claim 9, wherein the at least one second shearing element is configured to define a space between the at least one first shearing element and the at least one second shearing element in the disengaged position.

12. The apparatus of claim 9, further comprising a movement mechanism configured to move the at least one second shearing element between the engaged position and the disengaged position.

13. The apparatus of claim 8, wherein the roller comprises at least two shredder disks extending radially from the roller and a roller spacer defining a space between the at least two disks.

14. The apparatus of claim 13, wherein the at least one first shearing element and the at least one second shearing element are axially aligned with the roller spacer between the at least two shredder disks.

15. A method for removing material from rotating equipment comprising:
rotating a roller assembly of the rotating equipment, the roller assembly comprising a cutter recess defined radially outward from a rotational axis of the roller assembly;
moving a cutter assembly including a blade within the cutter recess parallel to the rotational axis of the roller assembly; and
cutting material collected on the roller assembly with the blade of the cutter assembly.

16. The method of claim 15, wherein moving the cutter assembly along the rotational axis of the roller assembly comprises driving a worm-drive screw coupled to the cutter assembly.

17. The method of claim 15, wherein moving the cutter assembly parallel to the rotational axis of the roller assembly comprises driving a cam.

18. The method of claim 15, further comprising returning the cutter assembly to a stored position after cutting the material collected on the roller assembly.

19. The method of claim 15, wherein moving the cutter assembly parallel to the rotational axis of the roller assembly comprises moving the cutter assembly while rotating the roller assembly.

20. The method of claim 15, wherein moving the cutter assembly along the axis of the roller assembly comprises:
stopping the roller assembly from rotating; and
moving the cutter assembly parallel to the rotational axis of the roller assembly after stopping the roller assembly from rotating.
